(19) United States
(12) Patent Application Publication
(10) Pub. No.: US 2012/0016661 A1
(43) Pub. Date: Jan. 19, 2012

(54) SYSTEM, METHOD AND DEVICE FOR INTELLIGENT TEXTUAL CONVERSATION SYSTEM

(76) Inventor: Eyal Pinkas, Rishon Lezion (IL)

(21) Appl. No.: 12/838,520

(22) Filed: Jul. 19, 2010

(51) Int. Cl. G06F 17/27

(52) U.S. Cl. 704/9

(57) ABSTRACT

A method of intelligent textual markup in an information exchange includes: determining semantic elements in said information exchange; determining relations between said semantic elements; representing said semantic elements as nodes in a directed graph; and representing said relations as edges connecting said nodes. A data processing system for enabling a visual representation of semantic relations in an information exchange includes: a semantic analysis engine adapted to determine semantic elements of said information exchange; a relation analysis engine adapted to determine relations between said semantic elements; and a presentation engine adapted to present said semantic elements as nodes and said relations as edges in a directed graph representing said information exchange.

### FIELD OF THE INVENTION

The present invention relates to a system, method and device for extracting, storing, querying, visualizing and expressing meaning of a text written in natural language.

### BACKGROUND OF THE INVENTION

Textual conversations (written correspondence, email or otherwise), chats, forums, blog entries and the like are increasingly prevalent on the internet. Such methods of conducting textual conversations often suffer from a number of deficiencies.

Often in such exchanges a number of issues may be raised, and generally speaking it is incumbent upon each party interested in following these issues to attend to the exact verbiage of the exchange.

A conversation may split to several distinct topics, yet the format of the discourse (e.g email) does not support the presentation of a split in a conversation. It will be appreciated that over a long and/or complex correspondence the number of separate and related issues that may be raised may become unwieldy, especially to one interested in determining which issues have been dealt with and which remain open. One problem with the linear structure of standard methods is that it is hard to follow which of the threads of the conversation have been addressed, and at which point.

Ambiguities inherent in a conversation may deter it from topics one or more parties intended to deal with, and may draw the conversation to unwanted directions. Detecting such ambiguities may take a long time, and explaining the ambiguity may take further time.

A conversation may repeat a previous conversation, conducted at an earlier time by one of the participants, or by a third party. Repeating the conversation may be redundant and time-consuming. For example, political debates may often revisit previous debates on the same topic that are publicly available.

Hence, an improved method for conducting textual conversations that addresses these issues is still a long felt need.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1 presents a visualization of a semantic search query.

FIG. 2 presents a visualization according to one embodiment of the current invention.

FIG. 3 presents a visualization of an analogy.

FIG. 4 presents a visualization of a product examination.

FIG. 5 presents a block diagram of one embodiment of the invention.

FIG. 6 presents a block diagram of one embodiment of the invention.

FIG. 7 presents a block diagram of one embodiment of the invention.

### SUMMARY OF THE INVENTION

The present invention comprises a system and method for visual representation of textual information. In particular, relations between various semantic elements of a textual exchange are indicated. In this way, a series of arguments and counter-arguments (for example) can be represented and easily understood visually as opposed to solely textually.

It is within the core of the present invention to provide a system for visualizing relations between semantic objects and other logical and linguistic entities. In one embodiment of the invention, entities are represented by vertices or nodes in a directed graph, and relations between these entities are represented by edges or directed arrows linking the nodes.

While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a semantic relation tool.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer e.g, 1, 5, or 10.

The term ‘text’ refers hereinafter to semantic information be it written, spoken, or otherwise transmitted or recorded. Thus a taped phone conversation, for the purposes of this document, is within purview of the term ‘text’.

The term ‘importance’ in relation to text refers hereinafter to the extent to which a certain text will be less accurately understandable if the said part of text is omitted from the text.

The invention provides a management system for analysis, tracking, visualizing, and reasoning about texts. These texts may for example be uploaded to a network by network users. The system provides a visual link between different objects (for example, texts written by users, URI from any network location, forum entries, blog posts, other textual correspondence, and other forms of communication such as voice). This link, which may for example be an arrow, line, Venn diagram, or the like as will be amplified below, expresses a semantic, logical, or other relation between lexical objects.

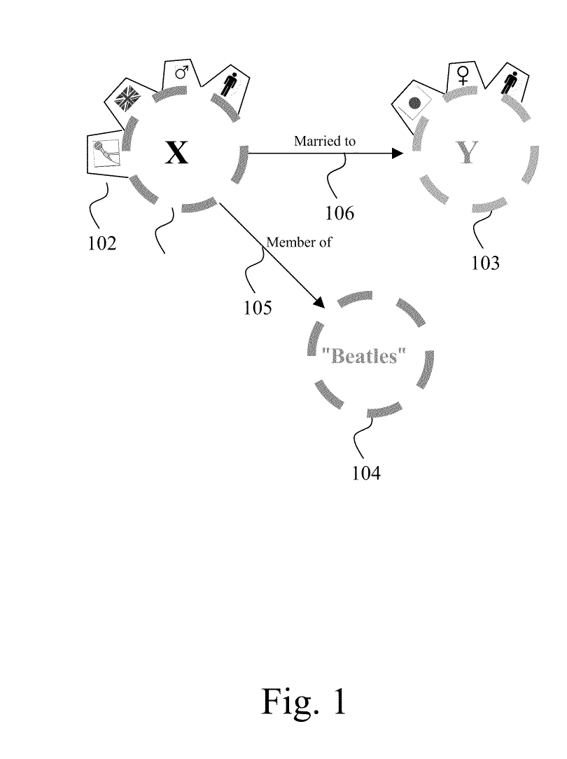

A simple example is shown in FIG. 1. Here, three entities 101, 103, 104 are shown, being labeled “X”, “Y” and “Beatles”. The entities are represented by the circles 101,103,104 and are in effect vertices of a directed graph; the edges (or arrows) of the graph 105,106 connect the entities. In this example, X is a ‘member of’ (104) the Beatles, and is ‘married to’ (106) entity Y. Various attributes 102 are shown surrounding the entities; for example entitiy X (101) has a ‘singer’ attribute 102 (represented by a microphone) as well as other attributes such as nationality (represented by a flag), sex, age, etc. It should be appreciated that such attributes in principle have the same standing as the links 104,106 and are simply represented in a different way.

For purposes such as website review or markup, the system allows a user to associate text with a website or other digital object, without requiring the website or digital object to make any changes or even be aware of this markup. This implementation will be referred to as web annotation.

In one implementation of the invention, the system recognizes content typed into various fields in a form—this may comprise text in any web site. The system then sends the information to a server running for purposes of implementing the invention's protocols. This way the system can be ‘ride on top’ of existing sites and existing conversations, and even to combine information from diverse sources. (for instance, a conversation may be carried out on several websites, with different experts on different sites dealing with different aspects of the same central issue.

In some embodiments of the invention, the content analyzed by the system comprises all forms of media, including video, sound, picture, and the like. For such purposes, the system is provided with software analyzers to parse the spoken sections of video, voice, or video or picture subtitles, and this semantic information is converted to text saved, and further analyzed by the system as any other text would be, with or without maintaining the original video/audio/picture information.

It is within provision of the invention to provide options for receiving input from SMS, email, or other messaging systems as will be clear to one skilled in the art.

It is within provision of the invention to comply with mobile devices, for example allowing the remote and/or local analysis of semantic information being sent to or from a mobile device. As mentioned above this semantic information may be derived from text messages, audio information (e.g. voice calls) and the like.

It is within provision of the invention to allow several different ways to view the primitive semantic information (e.g. plain text) involved in a given exchange, depending on user preferences. For example, take the case of a debate. A user (for instance) will see unanswered claims raised in the debate prominently displayed, and those claims that have been addressed are presented in a manner that illustrates the strength of response. A claim which both sides of the debate acknowledge has been rebutted is presented in a light color, or faded, or in a small font, with strikethrough, or in any other way tending to indicate the status of this claim.

As another example consider a recipe book: for this purpose the invention provides various views, such as: display preparation, shopping list, photo album, displays of nutritional values, etc.

It is within provision of the invention to update views in real time, or any specific time periods or intervals. The system is structured so that one can expand it by adding views. New views may optionally be written by users, for example by means of software plug-ins, or special purpose applications, such as web applications, or by providing a document that describes the view in a defined format (for example a type of xml document or other markup language).

The display also contains semantic processing requests that may filter or otherwise affect the display of the system. Thus if the system eventually obtains a large amount of information about a certain entity, the information actually displayed will be limited to that which is relevant in a particular context—the display shows only some of the information available, and for this purpose queries the system to know what to display according to its schema.

At every level of interaction, the user can insert facts or other structures to the system, thus effectively expanding it in the fashion of a ‘wiki’ or by similar means as will be obvious to one skilled in the art.

At the lexical level, new words, word combinations, or meanings may be introduced, including slang. An example would be the common meaning of the phrase “hi-five” as opposed to its literal meaning.

At the syntactic level new sentence structures may be introduced, even if they are not grammatically correct.

At the semantic level, new conversational devices may be introduced, like such as types of arguments in a debate. For example, the ‘Argumentum ad populum as a rhetorical device may be introduced into the system.

It is within provision of the invention to allow for operation in multiple languages. Each language has its own lexicon, grammatical structures, unique slang expressions, and the like which are represented by the system. As is known from the field of machine translation, it is not always possible to translate directly (for example automatically, by using literal meanings) from one language to another. Thus it is within provision of the system to use an abstract language to represent the semantic information gleaned from a particular text or other source. This abstract language is used as a medium for converting text from one language to another, whenever possible.

The system may include a set of users having some relation to one another, such as in social networks. The system will also preferably support standard authentication services such as OpenID, thereby allowing users to connect using accounts that they have on social networks and other systems, and vice versa.

It is within provision of the invention to allow the user the option to upload a more complex text, for instance text with markup such as HTML, XML, RDF (resource description framework) or the like.

It is within provision of the invention to control the amount of exposure a given text is given, (for example specifying public/private/friends/custom levels of exposure)

It is within provision of the invention that organizations can promote their content to appear higher in various searches, free or as a paid service. This provision is referred to hereinafter as Agenda-Push.

It is within provision of the invention that the logical objects used by the system are URI objects, and it is within provision of the invention that some or all can be accessed outside of the system. These objects can be used to represent (for instance) lexical units, semantic units, syntactic units, and relations between these.

### Information Analysis

The system analyzes a given text (or other lexical data) on 3 main levels:
a. Lexical—single-word analysis
b. Syntactic—Analysis of clause-level and sentence-level syntax, sentence structure, and to a lesser degree paragraph or section structure. (This level recognizes sentence parts such as subject, object, verb, noun, etc.)
c. Semantic—analysis of the meaning of a text.

The semantic analysis referred to above may include several levels. In one embodiment of the invention three levels are used:
a. Level 1 semantic analysis determines association of subjects between sentences. (For example, the word ‘He’ usually refers to someone mentioned in the previous sentence), and relations between objects (A said to B)
b. Level 2 semantic analysis determines the role of the clause, sentence or a collection of sentences, or paragraph. For example, the words “Title”, “example”, “greeting”, “counter-argument”, “referral to source”, etc. all are clues to the role of nearby text.
c. Level 3 semantic analysis determines the character of a paragraph or larger section of text. For example, at this level the system of the invention categorizes texts into “debate”, “allegory”, “contract”, etc.

Optionally, all textual information is analyzed by software running at the client or the server. For example the system can be implemented using any of the following configurations:
a. Lexical analysis is done with the client, the rest of the server's operation.
b. Lexical and syntactic analysis is performed by the client, while semantic analysis is performed at the server.
c. All analysis is performed at client.
d. All analysis is performed at server.

It is further within provision of the invention to use other combinations for locations of various stages of analysis, as will be clear to one skilled in the art.

It is further within provision of the invention that the locations for various stages of analysis be controllable, for example by the user.

The semantic analysis of the invention may be represented in a special format. Examples of formats suitable for this representation include RDF (resource description framework), Owl, Daml+Oil, CycL, and others. A further possibility is that the semantic information will not be saved, but rather that text will be analyzed each time it is recalled for use, display, or transmission.

The user will have access to the analysis of the text he was writing/reading, at all levels. In particular, the user can see a visual representation of the analysis, and can turn on and turn off various aspects of this visual representation at every level and every stage.

Thus the visual representation is user configurable.

It is well known that certain phrases may be inherently ambiguous. For example, the phrase “Joseph visited Ophir from New York” may mean that Joseph traveled from New York to visit Ophir, or that Joseph visited Ophir, who was from New York. The system can deal with such cases in a variety of ways, for example showing several visual representations, each optionally with a likelihood also displayed (e.g. by means of color, rating, prominence, order, or the like).

Inherent ambiguity (or multiple meanings) is an inevitable part of any human language (as opposed to a programming language, for example). Thus an inability to decipher text unambiguously does not reveal a ‘fault’ of any particular analysis system, but a limitation inherent in the problem itself.

To deal with multiple meanings at various levels, every analysis module is provided with a method to rank options, and displays the most likely option or top most likely options, in some embodiments with indication as to their likelihood. This rating will rely, amongst others, on:
a. Frequency of semantic alternatives. For example: the word ‘sun’ meaning the star at the center of our solar system, is for an average text the more likely meaning than the company named Sun. For purposes of determining such likelihood of meaning, the system may be taught using texts containing common usage, either by the system operator or by each user. The system will then rate alternatives in accordance with the frequencies encountered in the user texts. Obviously the texts used may be global or ‘local’ in scope; for instance, the meanings of terms used by two conversant may be determined by the meanings of identical terms in those conversant other conversations.
b. Analysis of high-level or lower-level meaning For example the sentence “Sun was bought by Oracle”. The word sun does not refer here to the sun, but the company Sun. Lexical level analysis may rank the astronomical meaning more likely, but syntactic level analysis (sentence structure) would rank this as an unlikely meaning because it creates a sentence structure that is invalid. Similarly, semantic-level analysis may be used to rate the probability of alternate meanings of the word ‘sun’.

The user is presented a passive indicator (such as red face, bold face, underlining or the like) for structures potentially having multiple meanings. The user is able to choose among the various options presented, or reformulate a draft automatically, to eliminate the ambiguity. For purposes of automatic drafting, the user selects options for interpretation that he intended, and the system looks for a different syntactic structure to express the same idea unambiguously.

It is within provision of the invention that the system will provide a mechanism for ranking the importance of each part of the text.

At the semantic level, the bulk of the sentence usually concerns subject and object—these are the most important parts of the text. Finding the syntactic level correspondence is more difficult, but possible (for example a text labeled as an example will generally not be the crux of the point.)

The system will thus have a representation of the essence of each text at each level.

Mapping of the text subject allows the system to summarize the text, and thereby make it appear in smaller area and in a more easily understandable way. This approach allows (for instance) zoom in/zoom out of the text, in the graph of a very large conversation.

### Learning

It is within provision of the system to include subsystems whose purpose is to learn how to improve the quality and accuracy of analysis at all levels. The semantic analysis is a particularly important goal for learning. Whenever the user corrects the system, this case is learned by the system and used for future analysis. In particular, solving inherently ambiguous texts can rely on such a learning mechanism to remove or reduce the ambiguity. The learning systems employed may perform (for example) statistical analysis—a rule that repeats itself many times, will be assigned a greater likelihood than one occurring but rarely.

It is within provision of the invention to utilize learning systems at the individual level, group level, language level, and global level:
a. Individual level—a subsystem analyzes only one user's activity at a time, and the conclusions drawn are relevant only to this user. This approach addresses the fact that different people use different expressions.
b. Group level—the system will identify a group of users who have linguistic features in common (for example groups that talk a lot together) and analyze these texts. This approach captures “common language” at group level.
c. Language level—all conversations held in a certain language will be analyzed, allowing the system's language model to evolve parallel to the language in the real world.
d. Global level—the system will identify global trends in the information provided to it.
   Interaction with the System During Writing

The system as described above continuously looks for existing structures that are similar to those being used in the conversation, at all levels—from the level of the individual word to the highest level of semantics. A rating mechanism is employed at every level of analysis. Thus user benefits in a number of ways:

The system will offer users continuations of phrases he writes, at the word level, phrase level, and otherwise, based on similar conversations or structures known to the system. For example the system may offer the user to insert at a given point a “sample element” to clarify the previous sentences. Based on the proposal of a familiar structure one can obtain reasonable responses to a thesis, for example: “The Americans did not land on the moon in '69—anyone can see that the photos show an artificial setting”, the system may provide the following possible responses:
1. “Who do you mean when you say ‘anyone’?” (Exposing ‘weasel words’)
2. How does an ‘artificial setting’ appear? (Disclosure, expert testimony, where the presenter of the thesis submits himself as an expert)
3. How do authentic photographs of a moon landing appear? (Again, expert testimony)
4. I think so too

This system can significantly speed up a conversation—if the conversation has been conducted in part or whole in the past, there is no need to repeat the redundant sections again. In such consultation or debate it may be more productive to jump to the “bottom line”. The system will offer to add the conversation tree to the conversation that already exists, which generally speaking may be larger and more detailed. In this way, the system allows the user to learn/discover new facts and ideas—it may be that a given discussion has already been conducted by more experienced people, with more knowledge. Perhaps the user is not willing to undertake a long conversation, but other users have already invested great effort in a similar conversation, and now their conversation tree is available to all other users, with the associated highly detailed arguments.

Communities gain by use of this system—a community of users with a common interest can share knowledge more conveniently by updating a common conversation tree. If a member of the community is looking for something, or wants to hold a discussion about something, already discussed by another community member, the system looks for all the information in the community's conversation-trees first, and gives them a high ranking as compared to other findings.

### Display

The style of text employed by the system includes features such as text color, background color, font, size, etc. It is within provision of the invention to provide standard text-editing features such as those found in word-processing tools, including provision for editing of HTML and/or other markup languages. The visualization employs style elements including text and other elements, for example comprehensive geometric shapes to highlight or group a few words, lines and arrows connecting objects (words, phrases, groups), text, graphs displaying text on different levels (syntactic or semantic), text bars allowing hiding and displaying of elements, and others as will be obvious to one skilled in the art.

It is within provision of the invention that the system will show or hide the styles or visualization at every level. That is, it will be possible to see the text literally, without any interference of the system, or to see various degrees of system-aided markup. The system will thus ‘style’ the text, depending on the selected view and the results of the different levels of analysis. As an example, consider the following scheme
a. Lexical level: one color is used for nouns, another color for verbs, etc.
b. Syntactic level: proper nouns displayed a larger font.
c. Semantic level: Titles will be in a different font, larger, bold, underlined, on a separate line, or the like.

A visualization display system is within provision of the invention, presenting visual information depending on the different levels of analysis. Using this system it is possible to see the syntax-tree of a sentence, the semantic-tree, semantic links between objects in text, etc. It is further within provision of the invention to show the semantic role of various passages in the text. For example, a whole section devoted to illustration by means of an example will be surrounded by a polygon and labeled ‘Example’.

All such text styles and visual language aids are user configurable to allow users to change styles at whim and to their liking.

Configurations (sets of views, styles, settings and the like) will be stored on the network, and it is within provision of the invention that these configurations can be shared and ranked by users of the system. Configurations are detailed, scalable and forward-compatible. In this way after adding a new visualization aid, it is possible to expand an existing configuration to use this new aid, allowing the user to use it and if desired to share it with other users.

One can adjust the system to automatically display a semantic analysis. For example: If the system detects that the text speaks about schedules, it will look for views that match schedules, and choose an appropriate view such as a ‘Gantt chart’ of actions vs. time, for example. The system decides what display looks more suitable at the moment.

The user is able to change views and rank views for example in order of preference. Each developer of a new view will indicate, for example using key words, the type of appropriate content for that view. Users may also mark the matching of different content views, and rank views for example in order of preference.

### Search

The system allows a simple search (for example keyword driven). The system also implements semantic search—search by object (for example in FIG. 1 represented with the letter X), noting the connections between this object and other objects, which are not necessarily known.

### Views

Some examples will now be provided of operation of the invention.

Task List view—a list of things yet to be done.

The system looks for sentences, clauses and paragraphs that may represent tasks, and creates a list of them. The system may tag clauses, sentences, or paragraphs as part of the “to-do list” involves semantic-level tagging. User control of the tagging will allow the user to reverse erroneous automatic tagging or to add tasks that the system missed tag. This information may be presented in tabular view as in the table below:

| Task | responsible party | Due date |
|---|---|---|
| Finish writing draft | Jeremy | 21.6.10 |
| Check draft | Amit | 22.6.10 |

Gantt View—like the view of tasks, but adding a schedule and dependencies.

Timeline view—Like the Gantt view, with one axis representing the implacable entity, time.

### Debate Management System

Displays for debate management will be based on a graph, each node in the graph representing a contention or argument and each arc representing a relation between contentions. Contentions having the same ultimate content will thus be represented by a single node, with the best expression of the argument being shown.

Rating of expressions of a given argument will be made by users, but also to a certain extent can be modified: for example the user may prefer to avoid offensive language for example, and one expression may be richer or more lucid than the others.

Arguments having similar meanings are grouped in a cloud of nodes. For example, if there is a common element in two arguments.

All text that is not strictly part of the debate will be hidden or displayed symbolically (for example by means of an icon representing expandable text). For example: If someone writes about an argument that “ . . . it reminds me of . . . ” this text is not displayed unless specifically expanded by its representative icon.

Users are given the opportunity to tag other people's texts as “irrelevant to the debate”, “particularly relevant”, “weak point”, “strong point”, and other semantic tags as will be obvious to one skilled in the art. This feature is a general feature of the system as a whole. The edge of the screen display will show statistics about the current debate: for example, a balance graph showing the strength of arguments for/against a particular point, how many observers are observing or taking part in the debate, how many system users side with a given side of the debate, and the like. Furthermore a quick index to the main debate points, list of answered/unanswered points, etc. is provided.

Analysis of the strength of an argument may be derived from several sources: the strength of the arguments that support a given contention, and the weakness of arguments opposing; the number of people supporting the contention (the ‘populist’ approach, aka Argumentum ad populum); the nature of the argument, and others as will be clear to one skilled in the art. For example, a purely mathematical argument is a simple presentation of axioms and theorems derived therefrom, with the standing of ineluctable fact as opposed to subjective opinion, and thus will be given a greater strength than a more subjective or speculative argument.

The strength of a given argument will affect the view of that argument—for example a darker background color, frame more pronounced, a larger bubble, etc. may be used to indicate an argument's strength, as determined by the system, by users thereof, or combinations of the two.

Some other views that may for example be used by the system:

Table view—an argument can be selected and a table displayed showing the points for and against.

“Critical” view—this view emphasizes to the user the most crucial elements of an argument. For example, a strong argument that weakens the position of the user, and has as yet had no response will be made more prominent. The user will then respond to the most pressing arguments. Similarly, an argument that the user published, and which has been weakened by another's response will be shown as important to some extent. In fact, this view emphasizes the weakest links of an argument for a particular party.

“Circuit” view—this view explains the logical structure of arguments and connections between them, as a diagram of logic gates.

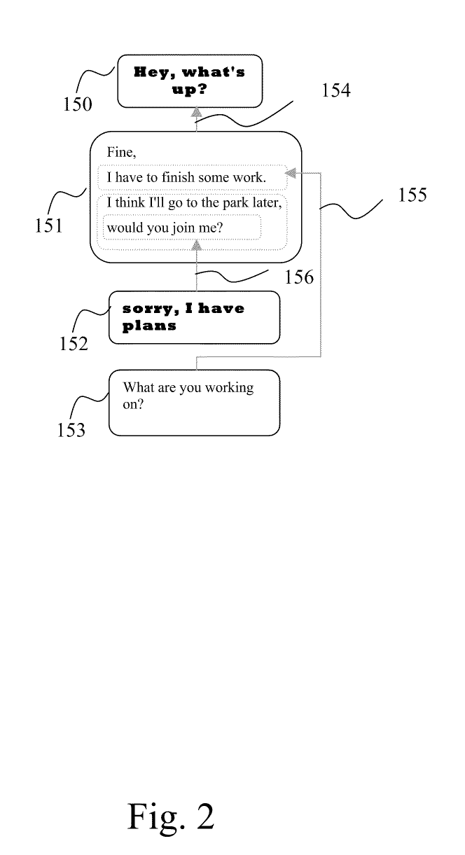

An example of one type of display used possibly used by the system is shown in FIG. 2. Here a section of a conversation is shown in text boxes 150-153, with different colors or fonts representing different speakers. These text boxes and text within them are linked by arrows 154,155,156 which link logically related items in the conversation. In this example one speaker mentions he/she must finish some work, and when the other speaker asks ‘what are you working on’ that question is linked to the first speaker's reference to the work by means of arrow 155. Similarly when the first speaker asks the second if he/she can join the first speaker in the park later, the second speaker's refusal is linked to the question by means of arrow 156.

The system identifies common argument structures (as part of its ability to identify semantic structures), including but not limited to:

Analogies—these contains semantic structure of objects and connections between them. An analogy is usually drawn between two such semantic structures, containing a similar number of objects and connections, with certain aspects in different contexts being similar.

For example: “The first Lebanon war was like Vietnam: both involved strong countries invading weak states, trying to enforce a regime change, both invading armies absorbed a lot of casualties, and finally both armies retreated without attaining the initial objectives.”

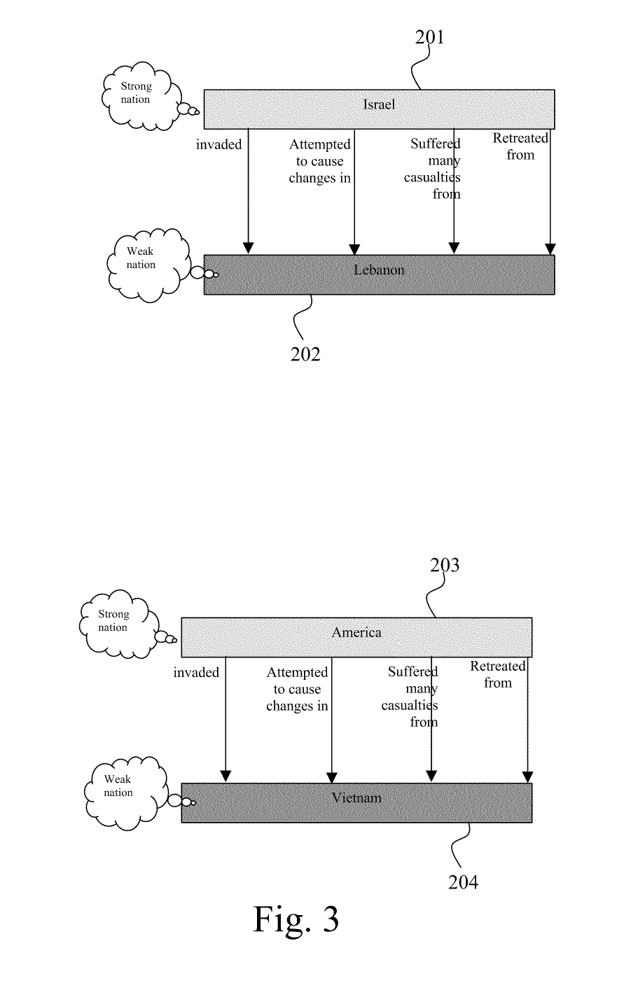

A visualization of such an analogy is shown in FIG. 3. Here the entities Israel (201) and Lebanon (202) are shown with a number of relations between them (arrows having the relation ‘invaded’, ‘attempted to cause changes in’, ‘suffered many casualties from’, and ‘retreated from’. Entity attributes (‘strong nation’ for Israel, ‘weak nation’ for Lebanon) are further shown. To illustrate the analogy, a similar illustration of the relations between the US (203) and Vietnam (204) are shown highlighting the identical relations ‘invaded’, ‘attempted to cause changes in’, suffered many casualties from', and ‘retreated from’ between the US and Vietnam as obtain between Israel and Lebanon, as well as the analogous attributes (‘strong nation’ for America, ‘weak nation’ for Vietnam)

Ad hominem—this is a logical fallacy in which one responds to an argument or assertion by reference to characteristics of the person presenting the argument or the assertion.

Statistical syllogism—this is a logical procedure asserting that if a proportion Q of population P has attribute A, and X is a member of P, then there is a probability corresponding to Q that X has attribute A.

Expert opinion—this is argumentation ‘by reputation’, based on the opinion of someone recognized (by some party) as an expert.

Contradiction or reduction ad absurdum—one supposes that a contention is true, and derives from these premises an impossible or absurd conclusion.

As will be clear to one skilled in the art there are many more such logical devices, fallacies, techniques, and operations, any of which may be represented by the extensible visualization system of the invention.

### Consumer Assistant

A consumer assistant application may be implemented by means of the invention, allowing a responsible and intelligent assistant to be conjured by the system.

The application might be for instance implemented on a cellular device, and may be used mainly in shops, supermarkets, shopping malls, etc. The behavior of such an application may be understood by means of example: The user scans the bar code of a product to his cell phone. The bar code is sent to the server, where it is translated to a product ID by appropriate means. The system then collects data about the product, which may be introduced by the user, other users, the manufacturer, etc. The system then sorts the information into a table that weighs various factors for and against the purchase of the product. Any consideration for/against this purchase has a set of weights, for instance a quality weight (e.g. “good product”=1, “very good product”=2), and weights assigning importance to various attributes. Types of attributes such as price, various health parameters, quality, FairTrade origin, animal rights issues, and others may be taken into account.

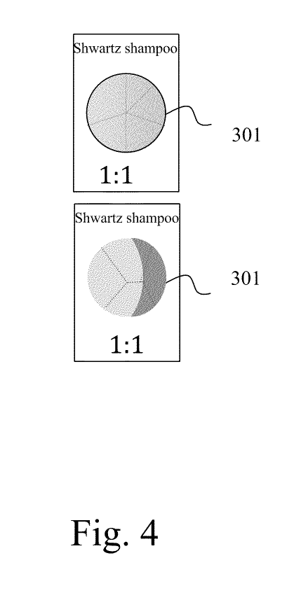

After weighing all the factors (which may be accomplished by means of a simple sum, user-provided function, or more complex function embedded in or generated by the system), the system displays the result graphically: for example consider FIG. 4. In the top example, the end result is 1:1, that is—arguments for and against arguments are equal. The bottom example shows a situation where the system detects a good buy, with strong arguments for the purchase vs. arguments against purchase at a 10:1 ratio. Boundaries 301 dividing the circle areas represent Arguments for/against. Clicking on such area shows details of the characteristic in question, and allows the user to delve into that aspect of the purchase. The size of each territory represents the weight that the user attaches to this attribute type. Data will be saved as a given that the overall system, including possible use in other programs. The user is able to control the display of this information and any other information of course.

### Organization Decision Making

This is similar to the consumer assistant application, only for organizations. The display is more sophisticated, and is intended to be displayed on a large screen and a mobile phone's screen.

An information repository is provided which has access to the company's private information and databases. A collection of views such as table view (for/against), SWOT table, and different graphs are available for presentation of various parameters concerning organizational structure, purchases, personnel changes, acquisitions and mergers, and other organizational decisions.

### Recipe Book

A recipe book may be implemented easily using the invention. Such a recipe book might be for instance provided with a number of simple views:
a. Classic view—shows the components first, and later the cooking process
b. Shopping List view—shows only the components
c. Display nutritional values—presents a table of nutritional values of the recipe, with the recommended diet compared to one or another (for example, the recommended daily dose of component X by the FDA is Y)
d. Gantt View—displays the cooking process, while addressing the dependencies between processes. So the user can recognize that while the pasta is cooking, the carrots can be chopped.

### Personal Belief Map

This preview shows all of the content that the user has made or expressed support for which express a particular position. When a user sends a query to the system about a dilemma (for instance a moral dilemma), one of the first displays is shown. The rationale is: first of all look for your previous decisions, and then ask externally. In addition, there may be enough information on the beliefs/principles in the system that one can query the system to determine what one believes. It is possible (this possibility being limited by the user) to allow other users access to one's belief-map, and vice versa. This allows users to examine a moral problem (for example) through the eyes of another user.

Benefits of the invention include:
a. Obviating repetition of conversational content, even someone else conducted the conversation.
b. Complex concepts and language setting—the system allows the user to define new meanings for words and phrases and use them later. In this way, the user does not have to explain every time what he means—meaning remains reserved for the system and everyone can see (depending on permissions)
c. One can specify more complex ideas that require a few sentences or paragraphs, and refer to any idea as a discrete object. Thus it is possible to name such an idea, or treat it without a name. For example: “Sorry I did not answer you. I thought you were dial-signing me”, “dial-signing” being defined as when one person communicates a bit of information to another person by means of dialing only, and not by talking The other person hangs up the call without answering. This is agreed-upon by both parties and both know the meaning of the dial-sign. The system allows users to introduce such terms as “dial-signing”, and make them available to all other users of the system, or any subset of that group.
d. Forms of sharing knowledge—connecting to a larger ‘conversational tree’
e. Creating a real dialogue—instead of publishing individual Web sites with one's profile or the like, people actually share opinions and information in one place, represented in one big graph.

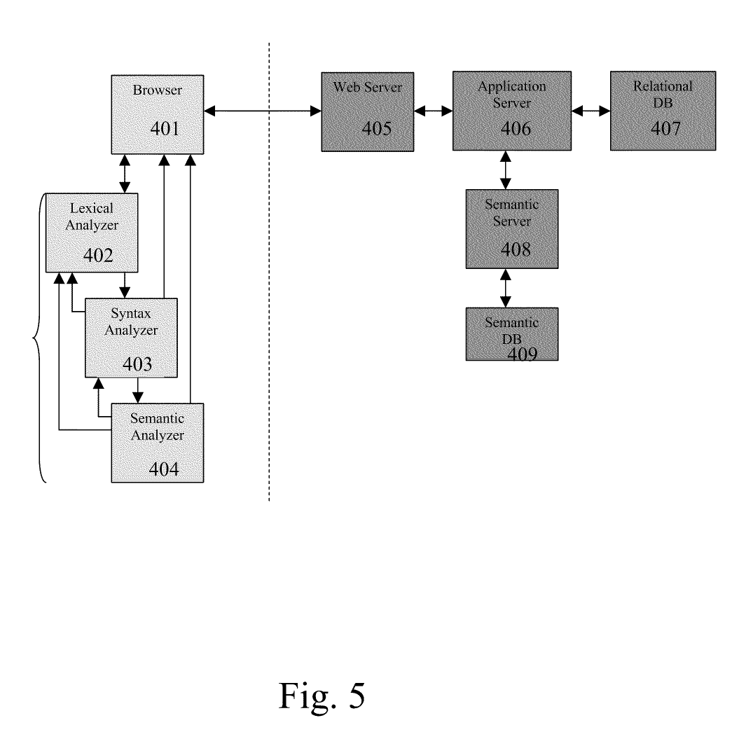

A possible block diagram detailing the device is shown in FIG. 5,6,7. In FIG. 5 the client side is shown to the left of the dotted line, comprising the browser 401, lexical analyzer 402, syntax analyzer 403, and semantic analyzer 404. The server side, to the right of the dotted line, comprises the web server 405, application server 406, relational DB 407, semantic server 408, and semantic database (DB) 409.

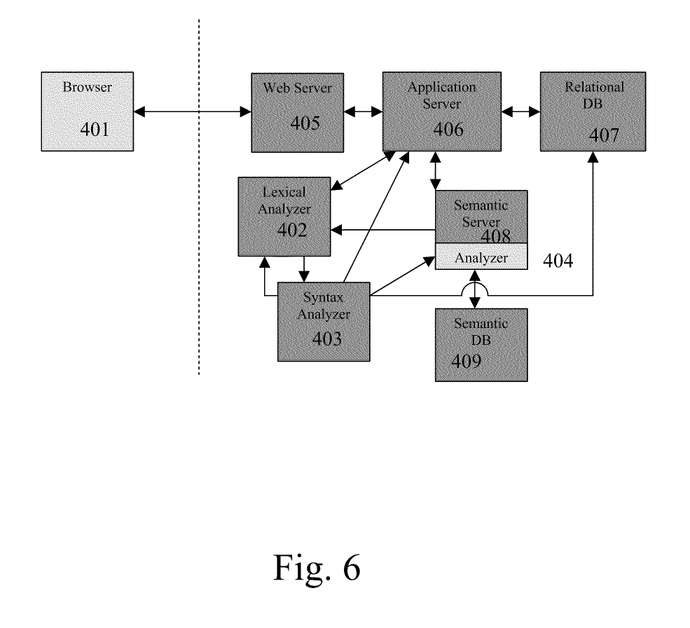

In FIG. 6 an alternative embodiment of the invention is shown wherein the semantic server 408 and analyzer 404 are both running on the server side of the operation, while on the client side only the browser 401 runs. The lexical analyzer 402, syntax analyzer 403, and semantic analyzer 404 all run on the client side in this embodiment.

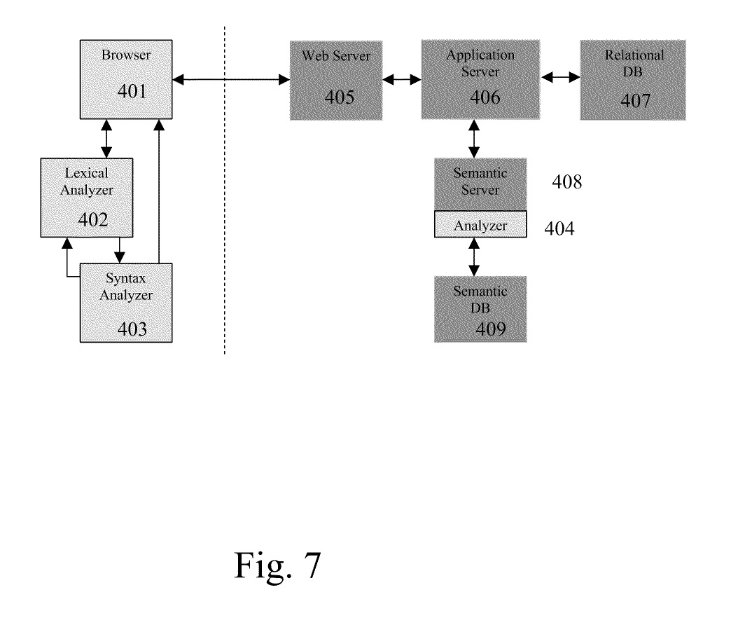

In FIG. 7 another embodiment of the invention is shown. The client side is shown to the left of the dotted line, comprising the browser 401, lexical analyzer 402, and syntax analyzer 403. The server side, to the right of the dotted line, comprises the web server 405, application server 406, relational DB 407, semantic server 408, semantic analyzer 404, and semantic database (DB) 409.

1. A method for intelligent textual markup in an information exchange consisting of:
a. determining semantic elements in said information exchange;
b. determining relations between said semantic elements;
c. representing said semantic elements as nodes in a directed graph;
d. representing said relations as edges connecting said nodes.

2. The method of claim 1 wherein said information exchange is selected from the group consisting of: written conversation, spoken conversation, text message, scholarly debate, online forum, recording, and blog post.

3. The method of claim 1 wherein said step of determining semantic elements in said information exchange comprises:
a. determining lexical elements of said information exchange;
b. determining syntactic information from said lexical elements;
c. determining semantic information from said syntactic information.

4. The method of claim 1, adapted for representation of at least one of the following: debates, analogies, metaphors, syllogisms, tasklists, timelines, recipe books, belief maps, discussion trees, forums, deliberations, votes, examinations, inspections, discussions, arguments, deliberations, contests, dialogs, chats, talks, conversations, negotiations, consultations, lectures, addresses, talks, discourses, seminars, symposia, and combinations thereof.

5. A data processing system for enabling a visual representation of semantic relations in an information exchange consisting of:
a. a semantic analysis engine adapted to determine semantic elements of said information exchange;
b. a relation analysis engine adapted to determine relations between said semantic elements;
c. a presentation engine adapted to present said semantic elements as nodes and said relations as edges in a directed graph representing said information exchange.

6. The system of claim 5 wherein said information exchange is selected from the group consisting of: written conversation, spoken conversation, text message, scholarly debate, online forum, recording, and blog post.

7. The system of claim 5 wherein said semantic analysis engine comprises modules adapted to:
a. determine lexical elements of said information exchange;
b. determine syntactic information from said lexical elements;
c. determine semantic information from said syntactic information.

8. The system of claim 5 adapted for representation of at least one of the following: debates, analogies, syllogisms, metaphors, timelines, tasklists, recipe books, belief maps, discussion trees, forums, deliberations, votes, examinations, inspections, discussions, arguments, deliberations, contests, dialogs, chats, talks, conversations, negotiations, consultations, lectures, addresses, talks, discourses, seminars, symposia, and combinations thereof.

9. The system of claim 5 adapted to display results of said analysis in conjunction with information from web sites.

10. A method for analysis of the strengths of a position consisting of:
a. determining a number of factors underlying said position;
b. assigning a weight to each of said factors;
c. assigning a value to each of said factors;
d. computing a final value based on said values and weights.

11. The method of claim 10 wherein said position is selected from the group consisting of: a position in a debate, a potential purchase, a decision, and a classification.

12. The method of claim 10 wherein said factors, weights, and values are determined by users of the system.

13. The method of claim 10 wherein said factors, weights, and values are determined by the system itself.
